(19) United States
(12) Patent Application Publication
(10) Pub. No.: US 2011/0240756 A1
(43) Pub. Date: Oct. 6, 2011

(54) Hydrant for snow making apparatus

(76) Inventor: Charles N. Santry, Chestnut Hill, MA (US)

(21) Appl. No.: 12/798,518

(22) Filed: Apr. 6, 2010

(51) Int. Cl. A01G 15/00; E03B 9/02

(52) U.S. Cl. 239/14.2; 137/272

(57) ABSTRACT

The present invention discloses a hydrant for selectively supplying water and air under pressure to a snow making apparatus having multiple water nozzles with corresponding water supply conduits and at least one air nozzle with a corresponding air supply conduit. The water hydrant includes a hydrant housing having a water inlet and an air inlet for respectively supplying water and air under pressure to respective water and air chambers within the housing from respective water and air sources. A valve operating shaft is mounted for axial rotation in the housing and spaced water and air valve seats are respectively mounted in the water and air chambers. Water and air valve actuators are secured to this shaft for axial rotation therewith and these actuators respectively rotatably engage the water and air valve seats for selectively valving multiple water ports in the water valve seat on and off while simultaneously valving at least one air port in the air valve seat on and off for selective supply of water and air under pressure to respective of the supply conduits feeding the snow making apparatus.

### BACKGROUND OF THE INVENTION

This invention relates generally to the art of valves, and more particularly to valves for supplying water and air under pressure to snow making apparatus.

Snow making apparatus of the type disclosed in U.S. Pat. No. 6,543,699 supply air and water under pressure to the top of a snow making tower where it is discharged under pressure through nozzles to form plumes of atomized water for producing snow in sub-freezing conditions. In actuality, the air supplied under pressure may be internally mixed with the primary water before it is discharged, or alternatively, the air under pressure may be discharged externally into the plumes of atomized water.

Additional water nozzles are positioned at the top of the tower to discharge more water in the form of spray. This additional supply of secondary water is independently valved for different ambient temperature conditions. The problem arises that the selective independent supply of additional water and the actuation also of the air supply must all be accomplished separately or independently as temperature conditions change. This, of course, requires multiple respective actuators to energize the different nozzle sets, and in addition, this arrangement is not conducive to remote actuation.

### SUMMARY OF THE INVENTION

The present invention provides a hydrant for snow making apparatus, such as snow guns or snow towers, having multiple water nozzles with corresponding water supply conduits, and at least one air nozzle with a corresponding air supply conduit.

The hydrant is comprised of a housing which has a water inlet and an air inlet for respectively supplying water and air under pressure to respective water and air chambers in the housing from water and air sources. A valve operating shaft is mounted for axial rotation in the housing and spaced water and air valve seats are respectively mounted in the water and air chambers within the housing. Water and air valve actuators are secured to this shaft for axial rotation therewith, and they respectively rotatably engage the water and air valve seats for selectively valving multiple water ports in the water valve seat on and off, and simultaneously valving at lease one air port in the air valve seat on and off for selective supply of water and air under pressure to respective of the supply conduits that supply the water and air nozzles. As a result, the present invention permits the control of air flow and water flow individually to multiple sets of water nozzles using a single valve shaft. This permits the use of one actuator, which may be remotely located for automation operation. In addition, a major cost savings is provided.

Generally, the water valve seat will have three or more water ports therein for valving to supply air and water under pressure to the snow making apparatus, such as the type illustrated in U.S. Pat. No. 6,543,699.

The water and air valve seats are comprised of plates that are mounted transversely to the operating shaft with the shaft passing through the plate. The valve actuators are comprised of discs having at least one radially extending finger rotatably engaging respective faces on the plates for valving the ports on and off at different selected positions of rotation of the shaft.

For automation purposes, the shaft may be selectively rotated with a motorized actuator from a remote location.

### BRIEF DESCRIPTION OF THE DRAWINGS

Other objects and advantages appear hereinafter in the following description and claims. The accompanying drawings show, for the purpose of exemplification, without limiting the scope of the invention or appended claims, certain practical embodiments of the present invention wherein:

FIG. 1 is a schematic representation of the hydrant of the present invention as connected to a snow making apparatus;

FIG. 2 is a perspective view of the housing for the hydrant of the present invention with the operating shaft and water and air valve seats and actuators removed;

FIG. 3 is a mid vertical cross sectional view of the housing shown in FIG. 2 as seen along section line III-III of FIG. 5;

FIG. 4 is a top view of the hydrant housing shown in FIGS. 2, 3 and 5;

FIG. 5 is a front view of the hydrant housing shown in FIG. 2, or a right side view in front elevation of the hydrant housing shown in FIG. 3, with portions thereof removed to disclose internal water passages;

FIG. 6 is a bottom view of the hydrant housing shown in FIG. 5;

FIG. 7 is a bottom view of the water valve seat prior to insertion into the bottom of the hydrant housing illustrated in FIGS. 2-6, with the valve seat face thereof presented;

FIG. 8 is a perspective view of the water valve seat shown in FIG. 7 as seen from the reverse side thereof;

FIG. 9 is a perspective view of the water valve actuator which seats on the water valve seat face presented in FIG. 7;

FIG. 10 is a perspective view of the water valve actuator shown in FIG. 9 illustrating the reverse or back side of the actuator which seats on the valve seat face surface presented in FIG. 7;

FIG. 11 is a perspective view of the air valve seat prior to insertion into the upper end of the hydrant housing shown in FIGS. 2-6 with the air valve seat face presented to the front of the figure;

FIG. 12 is a back view of the air valve seat shown in FIG. 11;

FIG. 13 is a view in side elevation of the air valve actuator which seats on the presented surface of the air valve seat shown in FIG. 11;

FIG. 14 is a perspective view of the air valve actuator shown in FIG. 13 as seen from the reverse side thereof which seats against the presented valves seat face of the valve seat shown in FIG. 11;

FIGS. 15A-15D show the water valve actuator as mounted on the water valve seat and the figures sequentially represent the water valve positions of off, water being supplied to one port, water being supplied to two ports, and water being supplied to three ports;

FIG. 16A is a view of the air valve actuator as mounted on its respective air valve seat with the air port in the air valve seat being closed off and thereby corresponding to the water valve off position illustrated in FIG. 15A; and

FIG. 16B is a view of the air valve actuator as mounted on the air valve seat with the air port shown in the open position to correspond to the open water port position illustrated in FIG. 15B.

### DETAILED DESCRIPTION OF A PREFERRED EMBODIMENT

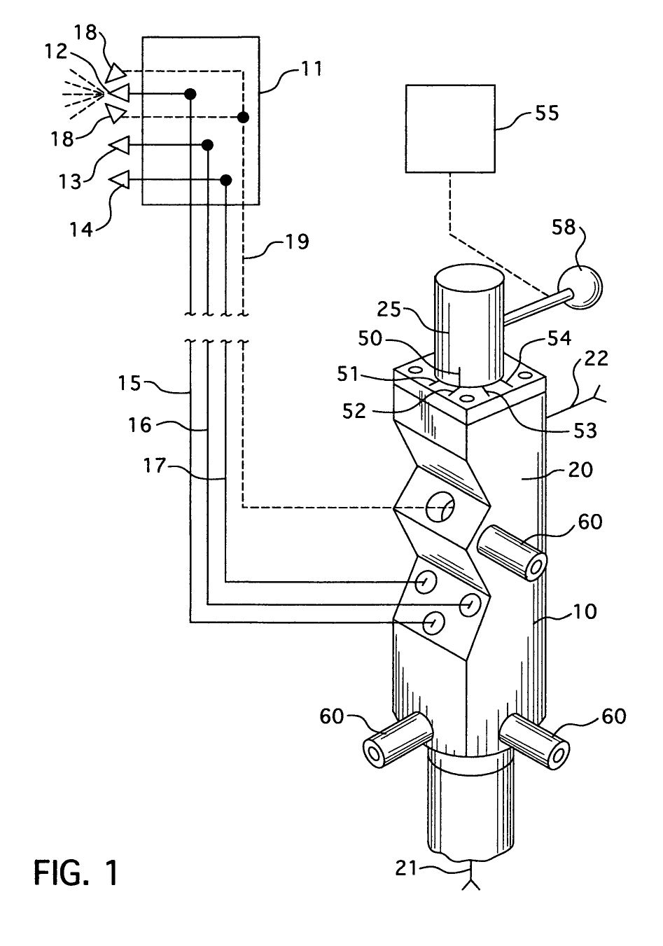

Referring to FIG. 1, the hydrant 10 of the present invention is provided for supplying water and air under pressure to snow making apparatus 11, which may be a snow gun or snow tower, having multiple water nozzles 12, 13 and 14 with corresponding respective water supply conduits 15, 16 and 17, and air nozzles 18 with a corresponding air supply conduit 19.

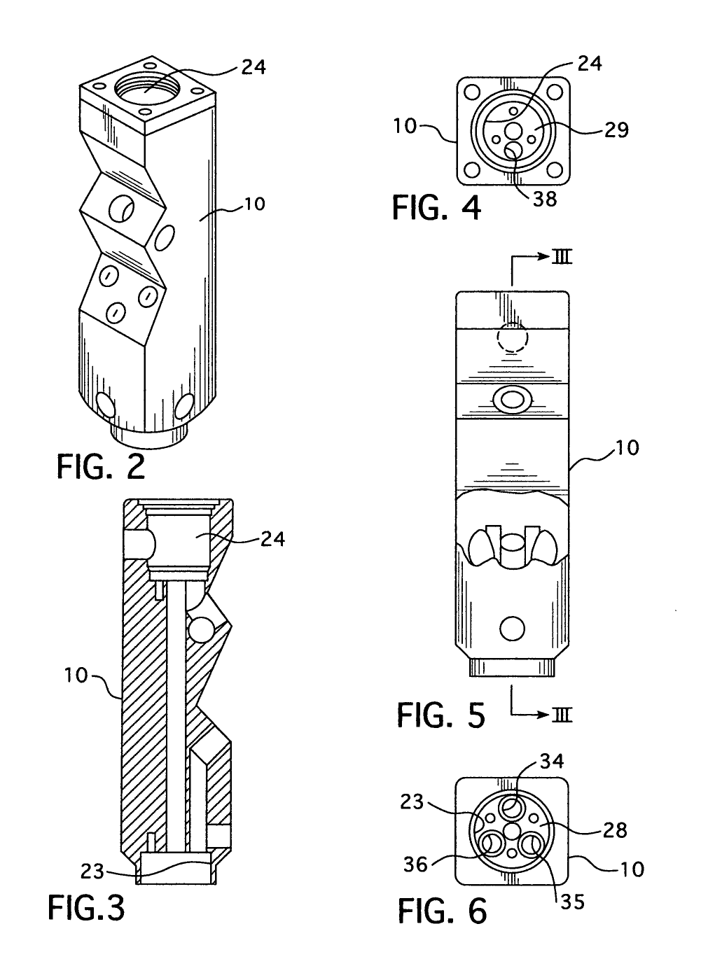

The hydrant 10 includes a hydrant housing 20 having a water inlet 21 and an air inlet 22 respectively supplying water and air under pressure to respective water and air chambers 23 and 24 (see FIGS. 2-6) in housing 10 from respective remotely located water and air sources (not shown).

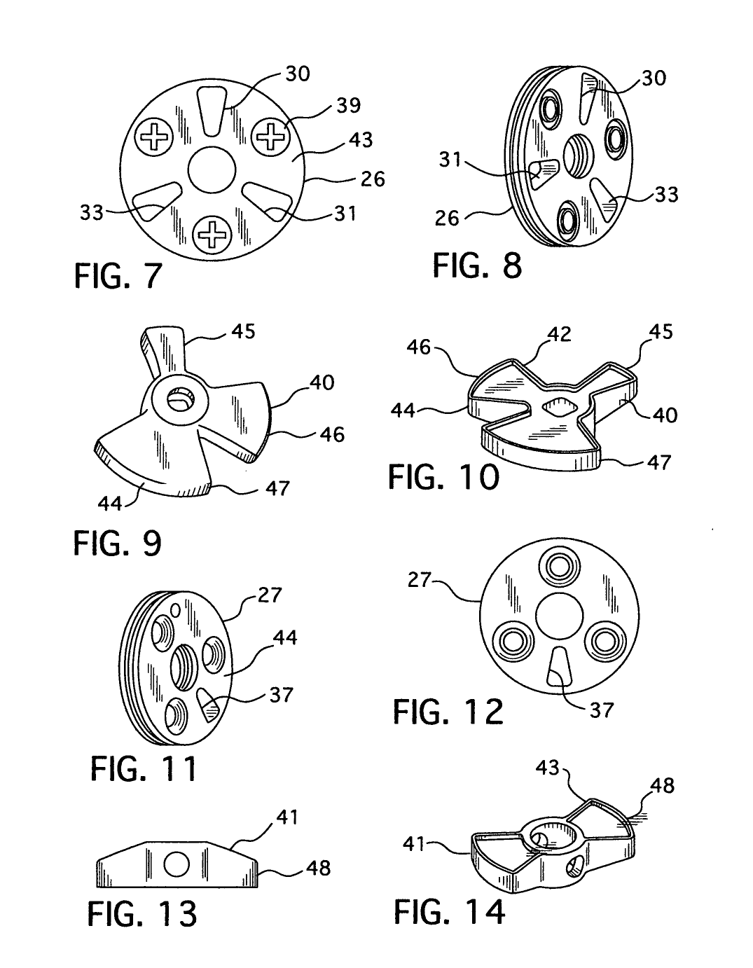

A valve operating shaft 25 is mounted for axial rotation in housing 10. Spaced water and air valve seats 26 and 27 (see FIGS. 7-16B) are respectively mounted in water and air chambers 23 and 24 and they seat and seal with O-rings respectively against faces 28 and 29 of chambers 23 and 24 with water ports 30, 31 and 33 in registration with underlying water channels 34, 35 and 36, and with air port 37 in registration with housing air channel 38 (see FIGS. 4, 6, 7, 8, 11 and 12). Water valve seat 26 and air valve seat 27 are respectively secured in position by machine screws 39.

Water valve actuator 40 and air actuator valve 41 are secured to shaft 25 for axially rotation therewith. The back seal face 42 of water actuator 40 slidably and rotatably engages water valve seat face 43 of water valve seat 26 for selectively valving the multiple water ports 30, 31 and 33 on and off. Simultaneously, air valve actuator 41 has its back or inwardly facing face 43 in rotatably sliding sealed engagement with the valve seat face 44 of air valve seat 27 so that air port 37 is simultaneously valved on and off with water port 30 for simultaneous selective supply of water and air under pressure to respective of the water supply conduits 15, 16 and 17 and the air supply conduit 19.

Water and air valve seats 26 and 27 are comprised of circular plates that are mounted transversely to shaft 25 with shaft 25 passing through both plates 26 and 27 for axially rotation therein with an O-ring seal.

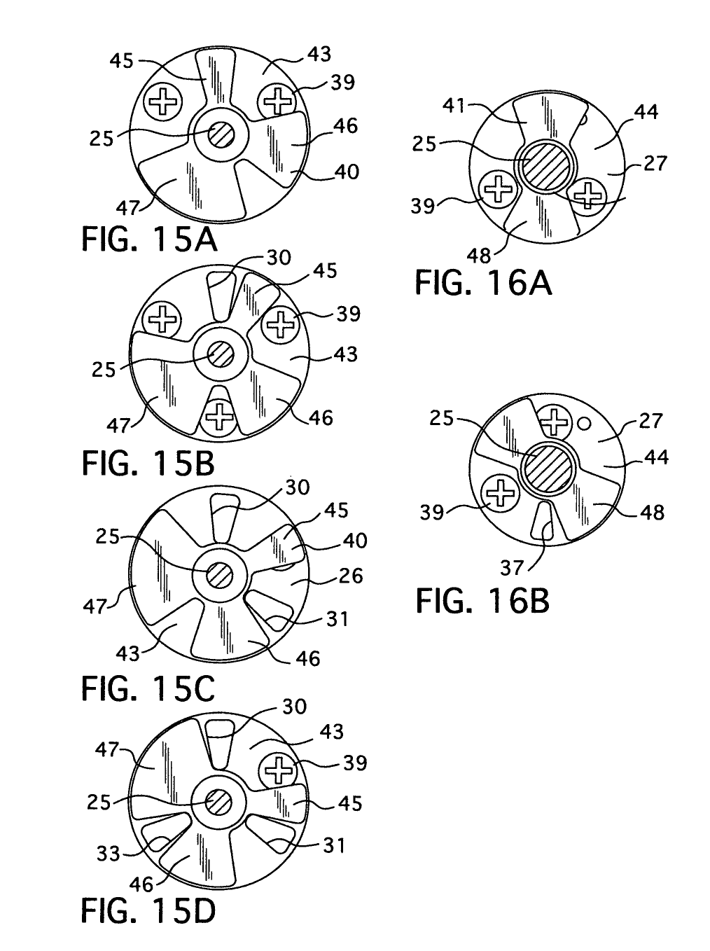

Water valve and air valve actuators 40 and 41 are also generally comprised of a disc shape. Water valve actuator 40 has three radially extending fingers 45, 46 and 47 which rotatably engage valve seat face 43 for valving off ports 30, 31 and 33 at preselected positions of rotation of shaft 25. Similarly, air valve actuator 42 has at least one radially extending finger 48 which engages the seat face 44 of air valve seat 27 for valving air port 37 on and off at preselected positions of rotation of shaft 25. This arrangement is best represented in FIGS. 15A-16B.

Referring to FIG. 1, shaft 25 has an indicator 50 thereon to indicate the rotary position of shaft 25 relative to housing 10. Shaft 25 may be rotated through 90° from off position 51 through 30° position 52, 60° position 53 on to the final 90° position at 54. These positions of valve actuation are respectively represented for water valve actuator 40 in FIGS. 15A, 15B, 15C and 15D respectively for the 0° position 51, the 30° position 52, the 60° position 53 and the 90° position 54.

At the 51 0° position shown in FIG. 15A, the valve actuator 40 closes off all three water ports 30, 31 and 33. Simultaneously, as shown in FIG. 16A, air port 37 in valve seat 27 is also closed off by actuator 41. When shaft 25 is rotated by handle 58 to the 30° position indicated at 52 on housing 10, water valve actuator 40 is positioned as illustrated in FIG. 15B while simultaneously positioning air valve actuator 41 in the position as shown in FIG. 16B. In this position, water port 30 is opened and air port 37 is opened, thereby supplying water under pressure to water nozzle 12 and air nozzles 18 of snow making apparatus 11.

Then, when shaft 25 is rotated to position 53, which is the 60° position, water valve actuator 40 is turned to the position illustrated in FIG. 15C thereby opening water port 31 in addition to water port 30 of valve seat 26 thereby supplying water not only to water nozzle 12, but also to water nozzle 13 of snow making apparatus 11. At this position air port 37 still remains open.

Lastly, when shaft 25 is rotated to the final 90° position 54, all three water ports 30, 31 and 33 are open thereby simultaneously supplying water to all three water spray nozzles 12, 13 and 14 of snow making apparatus 11. Once again, in this position, air port 37 remains open. When the shaft 25 is in the off position 51, automatic drains 60 drain water from lines 15, 16, 17 and 19 due to lack of pressure in the system in order to prevent freezing in the lines.

Accordingly, as the ambient sub freezing temperatures become lower, additional supply of water may be valved also on to water nozzles 13 and 14 through a single valve actuation system provided by hydrant 10.

Hydrant 10 may also be remotely actuated with a motorized actuator 55 from a remote location. Such motorized actuators are generally electrically operated and are readily available on the market.

I claim:

1. A hydrant for a snow making apparatus having at least one water nozzle with corresponding water supply conduits and at least one air nozzle with corresponding air supply conduits, said hydrant comprising:
a hydrant housing having a water inlet and an air inlet for respectively supplying water and air under pressure to respective water and air chambers in said housing from water and air sources;
a valve operating shaft mounted for axial rotation in said housing;
spaced water and air valve seats respectively mounted in said water and air chambers; and
water and air valve actuators secured to said shaft for axial rotation therewith and respectively rotatably engaging said water and air valve seats for selectively valving at least one water port in said water valve seat on and off and simultaneously valving at least one air port in said air valve seat on and off for selective supply of water and air under pressure to respective of said supply conduits.

2. The hydrant of claim 1, said water valve seat having three of said water ports therein for valving.

3. The hydrant of claim 1, said water and air valve seats comprised of plates mounted transversely to said shaft with said shaft passing through said plates, and said valve actuators comprised of discs having at least one radially extending finger rotatably engaging respective faces on said plates for valving off said ports at preselected positions of rotation of said shaft.

4. The hydrant of claim 1, wherein said shaft is selectively rotated with a motorized actuator from a remote location.
